(19) United States
(12) Patent Application Publication
(10) Pub. No.: US 2021/0148025 A1
(43) Pub. Date: May 20, 2021

(54) SKINNED PRODUCT

(71) Applicant: TOYODA GOSEI CO., LTD., Kiyosu-shi (JP)

(72) Inventor: Taichi Iwahashi, Kiyosu-shi (JP)

(21) Appl. No.: 17/095,807

(22) Filed: Nov. 12, 2020

(30) Foreign Application Priority Data
Nov. 19, 2019 (JP) 2019-208690

(51) Int. Cl. D05B 1/06; B60R 13/02

(52) U.S. Cl. CPC D05B 1/06; B60R 2013/0293; B60R 2013/0281; B60R 13/02

(57) ABSTRACT

A skinned product includes: a base material; a skin disposed on a surface of the base material; and a stitch line including a plurality of stitches arranged so as to form a linear shape on the skin. The stitches are formed by a needle thread penetrating the skin in a thickness direction from a front side and a bobbin thread intersecting with the needle thread on a back side of the skin. At least an end portion of the bobbin thread in a length direction of the stitch line is locked from the back side to the skin by an adhesive tape disposed between the base material and the skin and attached to a back surface of the skin.

### CROSS-REFERENCE TO RELATED APPLICATION(S)

This application is based upon and claims the benefit of priority from prior Japanese patent application No. 2019-208690 filed on Nov. 19, 2019, the entire contents of which are incorporated herein by reference.

### BACKGROUND

### 1. Field of the Invention

The present invention relates to a skinned product in which a stitch line is formed on a skin.

### 2. Description of the Related Art

For example, as an interior part such as an instrument panel, a console box and a door trim of an automobile, there has been known a skinned product in which a skin is disposed on a base material. As one form of the skinned product, there has been known a product in which a stitch line that simulates sewing of parts is formed on a skin to provide an appearance of using real leather and create a sense of quality.

In the skinned product, an needle thread and a bobbin thread are used and the skin is sewn by a sewing machine, whereby a stitch line including a plurality of stitches arranged so as to form a linear shape is formed on the skin. The skin having the stitch line is attached to a surface of the base material.

In the skinned product, in order to prevent fraying of the stitch line, for example, as described in JP-A-2017-65186, an end portion of the stitch line on a sewing start side and an end portion thereof on a sewing end side are subjected to backstitch, that is, sewing directions go backward, and backstitch portions are formed at the end portions.

However, when the backstitch portion is formed on a design surface of the skinned product, the backstitch portion is visible to an occupant, and an appearance of the skinned product is deteriorated.

The present invention has been made in view of the above circumstances, and an object thereof is to provide a skinned product capable of achieving both prevention of fraying of a stitch line and improvement in appearance.

### SUMMARY

According to an aspect of the present invention, there is provided a skinned product including: a base material: a skin disposed on a surface of the base material; and a stitch line including a plurality of stitches arranged so as to form a linear shape on the skin, the stitches being formed by a needle thread penetrating the skin in a thickness direction from a front side and a bobbin thread intersecting with the needle thread on a back side of the skin, where at least an end portion of the bobbin thread in a length direction of the stitch line is locked from the back side to the skin by an adhesive tape disposed between the base material and the skin and attached to a back surface of the skin.

According to the above configuration, at least the end portion of the bobbin thread in the length direction of the stitch line is locked to the skin by the adhesive tape to be restrained from moving. Therefore, the stitch line is unlikely to fray even when an external force is applied to the bobbin thread before the skin is fixed to the base material. In order to prevent fraying of the stitch line, different from a related-art skinned product, it is not necessary to perform backstitch to form a backstitch portion.

The locking is performed from the back side to the skin. Moreover, the adhesive tape for the locking is disposed between the base material and the skin and is attached to the back surface of the skin. A locking portion of the end portion to the skin does not appear on the front side of the skin. Therefore, different from the related-art skinned product in which the backstitch portion is visible from the front side, the locking portion of the end portion to the skin and the adhesive tape are invisible from the front side of the skinned product. It is possible to prevent deterioration of an appearance due to these being visible from the front side of the skinned product.

In the skinned product, it is preferable that the adhesive tape is disposed so as to straddle the bobbin thread in an intersecting direction intersecting with the stitch line, and is attached to both side portions of the bobbin thread in the intersecting direction on the back surface of skin.

As in the above configuration, the adhesive tape is disposed so as to straddle the bobbin thread in the intersecting direction intersecting with the stitch line, whereby the bobbin thread is attached to the adhesive tape and fixed to the adhesive tape. The adhesive tape is fixed to the skin by being attached to both side portions of the bobbin thread in the intersecting direction on the back surface of the skin. As a result, the end portion of the bobbin thread is locked to the back surface of the skin via the adhesive tape to be restrained from moving.

In the skinned product, it is preferable that at least an endmost portion of the end portion of the bobbin thread is sandwiched between the back surface of the skin and the adhesive tape attached to the back surface.

According to the above configuration, since at least the endmost portion of the end portion of the bobbin thread is sandwiched by the adhesive tape and the base material, an external force tending to fray the stitch line is less likely to be applied directly to the endmost portion of the end portion of the bobbin thread. Therefore, the fraying of the stitch line is effectively prevented.

According to the skinned product, the prevention of fraying of the stitch line and the improvement in appearance can be both achieved.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a view showing an embodiment in which a skinned product is embodied in an instrument panel of an automobile, and is a partial front view showing a part of the instrument panel;

FIG. 2 is a sectional view taken along line 2-2 in FIG. 1:

FIG. 3 is an enlarged partial sectional view showing a part of FIG. 2; and

FIG. 4 is a sectional view taken along line 4-4 in FIG. 3.

### DETAILED DESCRIPTION OF THE INVENTION

Hereinafter, an embodiment in which a skinned product is embodied in an instrument panel of an automobile will be described with reference to the drawings.

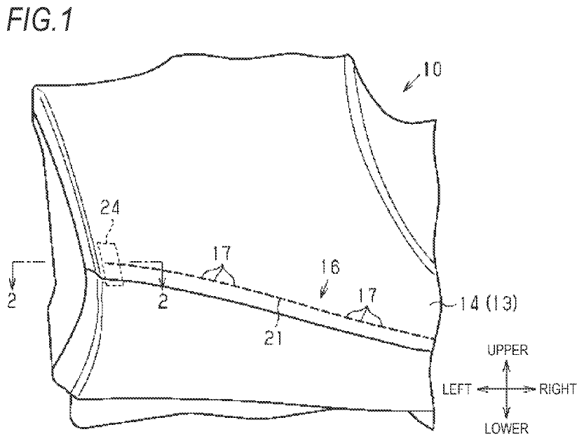

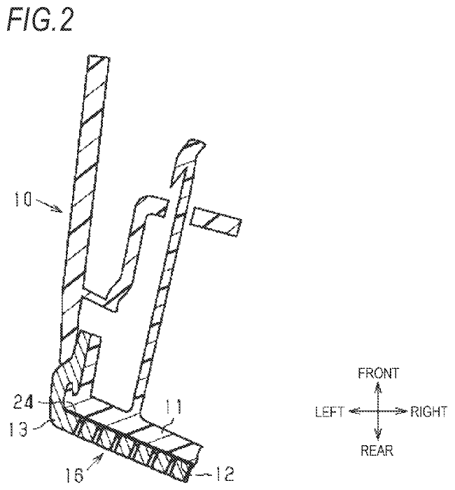

The instrument panel extending in a vehicle width direction is disposed in a front portion of a vehicle interior of the automobile. As shown in FIGS. 1 and 2, an instrument panel 10 includes a base material 11, a skin 13 and a stitch line 16. Next, components of the instrument panel 10 will be described.

<Base Material 11>

The base material 11 is a member that forms a skeleton portion of the instrument panel 10, and has a non-planar surface (a three-dimensional surface) such as a curved surface, a bent surface and an uneven surface. The base material 11 is formed by resin molding such as injection molding using a resin material such as polypropylene (PP), polycarbonate (PC), or acrylonitrile-butadiene-styrene copolymer (ABS).

<Skin 13>

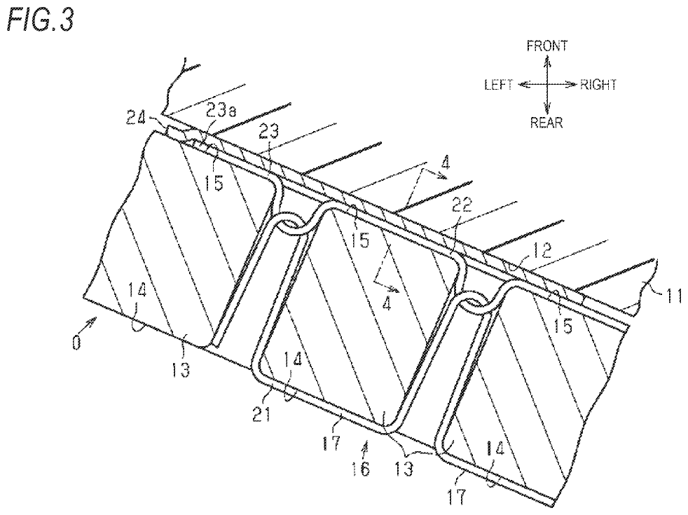

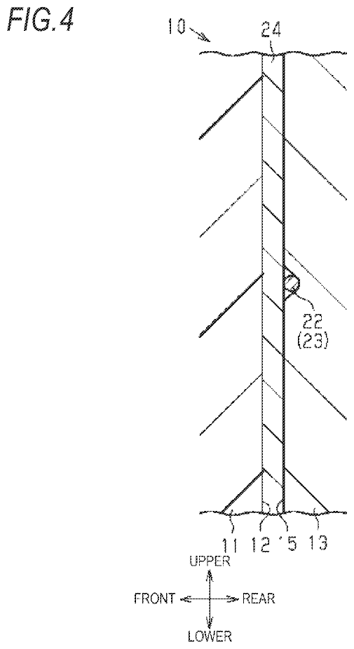

The skin 13 is a member constituting a design surface of the instrument panel 10, and is disposed so as to overlap a surface 12 of the base material 11. As shown in FIGS. 3 and 4, the skin 13 is deformed along the surface 12 of the base material 11, and is attached to the surface 12 via an adhesive layer (not shown) formed of an adhesive. The skin 13 may be attached to the base material 11 by a double-sided tape or a pressure-sensitive adhesive instead of the adhesive.

The skin 13 is mainly used for a purpose of improving a texture, a tactile sensation and the like of the instrument panel 10. The skin 13 is formed into a sheet shape having a uniform thickness by synthetic leather formed of vinyl chloride, thermoplastic elastomer (TPO) or the like.

Although not shown, the skin 13 may be formed of a skin layer and a soft layer laminated on a back side of the skin layer. The soft layer is attached to the skin layer to be integrated with the skin layer.

The skin 13 may have wrinkles (wrinkle patterns) on an surface thereof as seen in a leather product.

<Stitch Line 16>

The stitch line 16 is formed on the skin 13 in order to give the instrument panel 10 an appearance of using real leather by simulating sewing of parts of the skin 13 to create a sense of quality, and is provided for a purpose of decoration.

The stitch line 16 according to the present embodiment is formed by sewing the skin 13 with a sewing machine using a needle thread 21 and a bobbin thread 22. The stitch line 16 includes a plurality of stitches 17 arranged along the vehicle width direction so as to form a linear shape on the skin 13. These stitches 17 are formed by the needle thread 21 penetrating the skin 13 in a thickness direction from a front side and the bobbin thread 22 intersecting with the needle thread 21 on a back side of the skin 13. A part of the stitches 17 appear intermittently on a surface 14 of the skin 13.

In the needle thread 21 and the bobbin thread 22, at least the needle thread 21 having a color different from that of the skin 13 may be used. By doing so, the stitch line 16 can be emphasized, and the appearance of the instrument panel 10 can be further improved.

As shown in FIGS. 1 and 3, an end portion 23 of the bobbin thread 22 in a length direction of the stitch line 16 is locked from the back side to the skin 13 by a band-shaped adhesive tape 24. Here, the end portion 23 refers to a portion of the bobbin thread 22 constituting the endmost stitch 17 of the stitch line 16 and a couple of stitches 17 from the stitch 17 toward an opposite end of the stitch line 16.

As the adhesive tape 24, a commercially available general one is used. The adhesive tape 24 is disposed so as to extend in an intersecting direction intersecting with the stitch line 16. In the present embodiment, a direction intersecting with the stitch line 16 at an angle orthogonal to or substantially orthogonal to the stitch line 16 is defined as the intersecting direction. As shown in FIGS. 1 and 4, the adhesive tape 24 straddles the end portion 23 of the bobbin thread 22 in the intersecting direction. The adhesive tape 24 is attached to both side portions (upper and lower sides in the present embodiment) of the bobbin thread 22 in the intersecting direction of a back surface 15 of the skin 13. As shown in FIG. 3, the end portion 23 of the bobbin thread 22 is sandwiched between the back surface 15 of the skin 13 and the adhesive tape 24. The end portion 23 also includes an endmost portion 23a.

Next, an action according to the present embodiment configured as described above will be described. In addition, effects caused by the action will also be described. In the present embodiment, the end portion 23 of the bobbin thread 22 is locked to the skin 13 by the adhesive tape 24. Therefore, the stitch line 16 is unlikely to fray before the skin 13 is attached to the base material 11. In order to prevent fraying of the stitch line 16, different from the related art, it is not necessary to perform backstitch to form a backstitch portion.

In particular, in the present embodiment, the adhesive tape 24 is disposed so as to straddle the bobbin thread 22 in the intersecting direction intersecting with the stitch line 16, whereby the bobbin thread 22 is attached to the adhesive tape 24 and fixed to the adhesive tape 24. The adhesive tape 24 is fixed to the back surface 15 of the skin 13 by being attached to the both side portions of the bobbin thread 22 in the intersecting direction. The end portion 23 of the bobbin thread 22 is locked to the back surface 15 of the skin 13 via the adhesive tape 24 to be restrained from moving. Therefore, the fraying of the stitch line 16 is effectively prevented.

Further, in the present embodiment, the endmost portion 23a of the end portion 23 of the bobbin thread 22 is sandwiched between the back surface 15 of the skin 13 and the adhesive tape 24. An external force tending to fray the stitch line 16 is less likely to be applied directly to the portion 23a of the bobbin thread 22. Therefore, the fraying of the stitch line 16 is effectively prevented also in this respect.

Locking using the adhesive tape 24 is performed from the back side to the skin 13. Moreover, the adhesive tape 24 is disposed between the base material 11 and the skin 13 and is attached to the back surface 15 of the skin 13. A locking portion of the end portion 23 to the skin 13 does not appear on the front side of the skin 13. Therefore, different from the related art in which the backstitch portion provided for the locking is visible from the front side, the locking portion of the end portion 23 to the skin 13 and the adhesive tape 24 are invisible from the front side of the instrument panel 10. It is possible to prevent deterioration of the appearance due to these being visible from the front side of the instrument panel 10.

According to the present embodiment, the following effects can be obtained in addition to the above.
In order to prevent the fraying of the stitch line 16, the adhesive tape 24 is simply attached from the back side of the skin 13 to the end portion 23 of the bobbin thread 22 and the back surface 15 of the skin 13. As the adhesive tape 24, the commercially available general one is used. Therefore, it is possible to take measures against the fraying of the stitch line 16 at low cost.
The adhesive tape 24 is attached only to portions of the bobbin thread 22 and the back surface 15 of the skin 13 that correspond to the end portion of the stitch line 16. Therefore, a use amount of the adhesive tape 24 can be reduced as compared with a case where the adhesive tape 24 is attached to a portion corresponding to a wide region including the end portion of the stitch line 16.
Since the adhesive tape 24 is thin, an amount of the skin 13 lifted from the base material 11 is small as the adhesive tape 24 is used. Therefore, it is possible to prevent deterioration of the appearance due to lifting.
It is also possible to fix the bobbin thread 22 to the back surface 15 of the skin 13 by using an adhesive. However, as the adhesive hardens, the skin 13 may become hard in a peripheral portion of the adhesive, resulting in a decrease in the tactile sensation. In this respect, in the present embodiment, the adhesive tape 24 is used for fixing the bobbin thread 22. The adhesive tape 24 is soft and flexible. Therefore, it is possible to prevent the decrease in the tactile sensation of the skin 13 as the adhesive tape 24 is used.

The above embodiment can also be implemented as modifications modified as follows. The above embodiment and the following modifications can be implemented in combination with each other as long as they do not have technical contradiction.

The end portion 23 of the bobbin thread 22 in the length direction of the stitch line 16 may protrude from between the back surface 15 of the skin 13 and the adhesive tape 24 attached to the back surface 15.
A portion of the bobbin thread 22 that is locked to the back surface 15 of the skin 13 by the adhesive tape 24 may be longer than that according to the above embodiment, provided that the portion includes the end portion 23 in the length direction of the stitch line 16.
The skinned product can also be applied to a skinned product in which the stitch line 16 is formed not only as a single stitch including one stitch line 16 as in the above embodiment, but also in a form called a double stitch including two stitch lines 16 extending in parallel with each other.
The skinned product can be applied to a center cluster that constitutes a central portion of the instrument panel in the vehicle width direction and in which various switches, navigation devices and the like are assembled.
The skinned product can be applied to an interior part different from the instrument panel of the automobile, for example, an interior part such as a console box, a door trim, a glove box and a pillar garnish.
The skinned product is not limited to an automobile interior part, and can be widely applied to a skinned product in which the needle thread 21 and the bobbin thread 22 are used and the stitch line 16 is formed on the skin 13.

What is claimed is:

1. A skinned product comprising:
a base material;
a skin disposed on a surface of the base material; and
a stitch line including a plurality of stitches arranged so as to form a linear shape on the skin,
the stitches being formed by a needle thread penetrating the skin in a thickness direction from a front side and a bobbin thread intersecting with the needle thread on a back side of the skin,
wherein at least an end portion of the bobbin thread in a length direction of the stitch line is locked from the back side to the skin by an adhesive tape disposed between the base material and the skin and attached to a back surface of the skin.

2. The skinned product according to claim 1,
wherein the adhesive tape is disposed so as to straddle the bobbin thread in an intersecting direction intersecting with the stitch line, and is attached to both side portions of the bobbin thread in the intersecting direction on the back surface of skin.

3. The skinned product according to claim 1,
wherein at least an endmost portion of the end portion of the bobbin thread is sandwiched between the back surface of the skin and the adhesive tape attached to the back surface.
